(19) United States
(12) Patent Application Publication
(10) Pub. No.: US 2020/0210257 A1
(43) Pub. Date: Jul. 2, 2020

(54) Deduplication of Application Program Interface Calls

(71) Applicant: salesforce.com, inc., San Francisco, CA (US)

(72) Inventors: Thomas Archie Cook, San Francisco, CA (US); Sahil Bhutani, San Francisco, CA (US); Praveen Savur, Santa Clara, CA (US); Alan Mathias Hoffman, San Francisco, CA (US); Ruthvik Krishna Murthy, San Francisco, CA (US)

(21) Appl. No.: 16/235,188

(22) Filed: Dec. 28, 2018

(51) Int. Cl. G06F 9/54; H04L 29/08

(52) U.S. Cl. CPC G06F 9/547; H04L 67/2842

(57) ABSTRACT

Embodiments regard deduplication of application program interface calls. An embodiment of an apparatus one or more processors to process data; a computer memory; and a network interface, wherein the apparatus includes an intermediary layer between one or more components of the apparatus and the network interface, the intermediary layer to perform deduplication of multiple server API calls from one or more components for the one or more APIs, wherein the deduplication includes one or more of preventing transmission of duplicated server calls from the one or more components to the one or more APIs; and generating one or more combined server calls based at least in part on the plurality of server API calls and transmitting the one or more combined server calls to the one or more APIs.

### TECHNICAL FIELD

Embodiments relate to techniques for computer database operations. More particularly, embodiments relate to deduplication of application program interface (API) calls.

### BACKGROUND

In a system in which a client directs application program interface (API) calls to a server, including, for example, a client in a multi-tenant database, there may be multiple calls transmitted to the server during a particular time period. Each call may include requests for one or more data elements.

However, requiring the server to respond to each of such calls from the client can create delay in API responses, thus having a negative impact on client experience in database operation. This impact may increase significantly with the size of the system, as the increase in the number of clients requesting data results in multiple request being sent and received at or near the same time.

Further, certain of the multiple API calls from a client may be duplicative, such calls requesting one or more common data elements. Addressing each of such duplicative calls separately can result in slow handling of requests by the server, even though the requests are directed at least in part to the same data.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of an apparatus or system to perform deduplication of server API calls according to one or more embodiments;

FIG. 2 is an illustration of deduplication of server API calls in an apparatus or system according to one or more embodiments;

FIG. 3 is an illustration of deduplication of server API calls to multiple APIs in an apparatus or system according to one or more embodiments;

FIG. 4 is an illustration of an apparatus or system to perform deduplication of server API calls including use of data caching according to one or more embodiments;

FIG. 5 is an illustration of an apparatus or system to perform deduplication of server API calls including use of data caching according to one or more embodiments;

FIG. 6 is a flow chart to illustrate a process for deduplication of server calls according to one or more embodiments;

FIG. 7 illustrates a block diagram of an environment in which an on-demand database service may be provided; and

FIG. 8 illustrates further details of an environment in which an on-demand database service may be provided.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description.

In some embodiments, an apparatus, system, or process is to provide for deduplication of application program interface (API) calls.

In some embodiments, an apparatus, system, or process is to provides deduplication of client API calls to a server (which may be referred to herein as a client to server call, a server API call, or simply a server call) through use of one or more intermediary layers (which may also be referred to as simply one or more layers) to handle API calls from components of a client.

In some embodiments, the deduplication of server calls may include, but is not limited to, the one or more intermediary layers to generate and transmit one or more combined or merged API calls to be transmitted from the client to the server API, receive one or more responses from the server to the one or more merged API calls, and to generate and transmit responses for each of the received requests to be directed to the respective components based on the one or more responses from the API.

In some embodiments, the one or more intermediary layers are further to provide for caching of data from API calls, and to utilize the cached data at least in part in the generation of responses to the client to server API calls. The one or more intermediary layers may include the Lightning Data Service of salesforce.com, inc.

In some embodiments, an apparatus, system, or process is to provide for deduplication of API calls in a database system, including a multi-tenant database system. However, embodiments are not limited to this structure, and may include other systems that include multiple components or clients making duplicative calls to one or more centralized servers.

While the examples illustrated in the drawings described below refer to server data having simple mathematical values for illustration purposes, embodiments are not limited to any particular type or quantity of data.

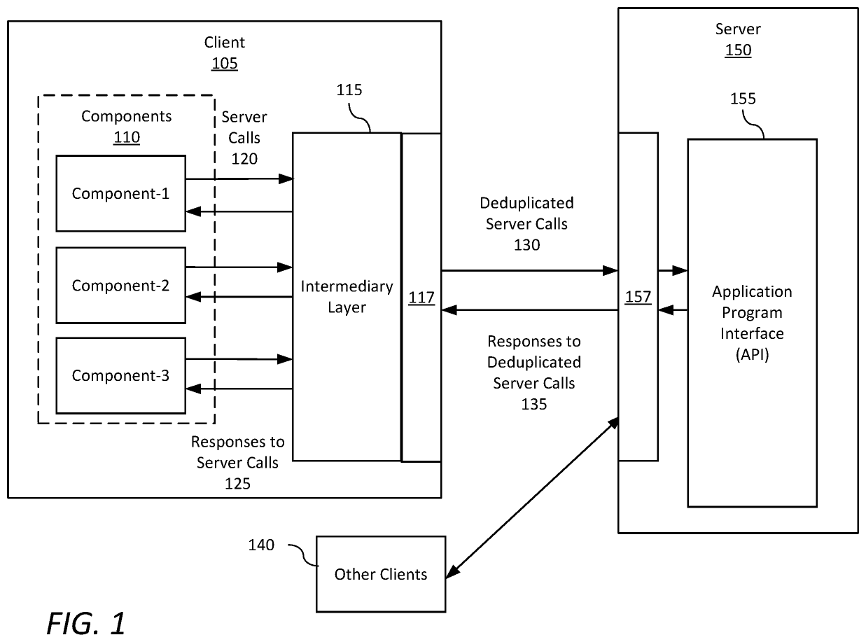

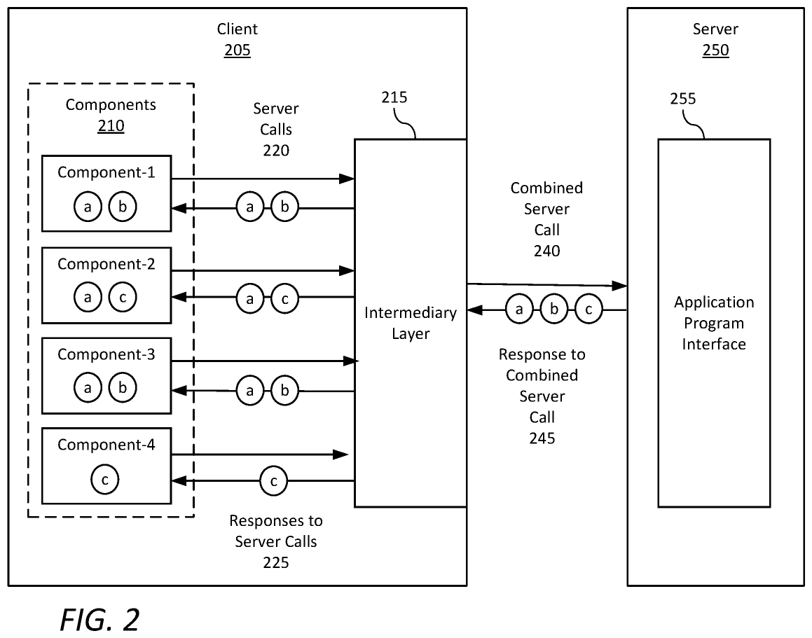

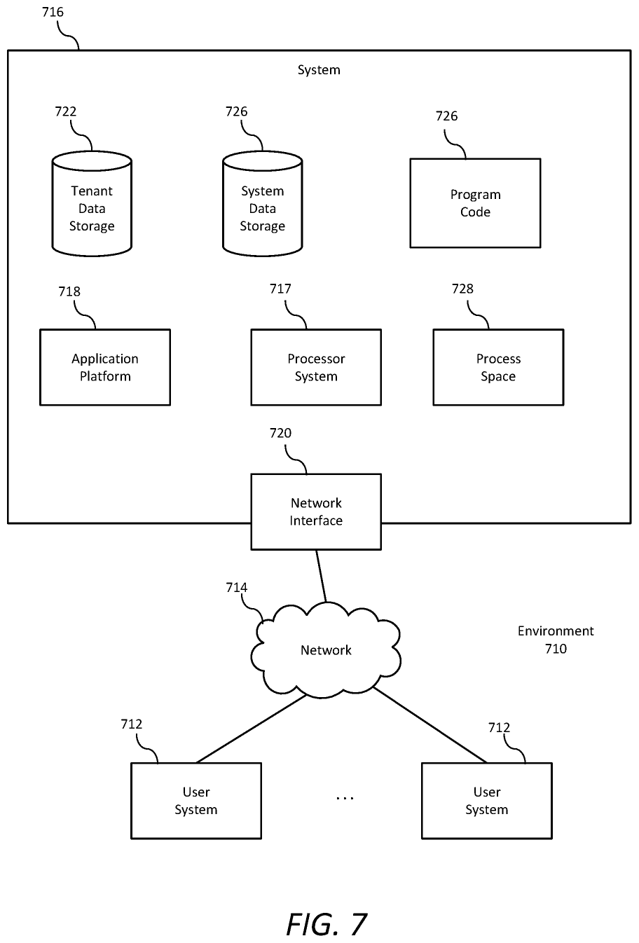

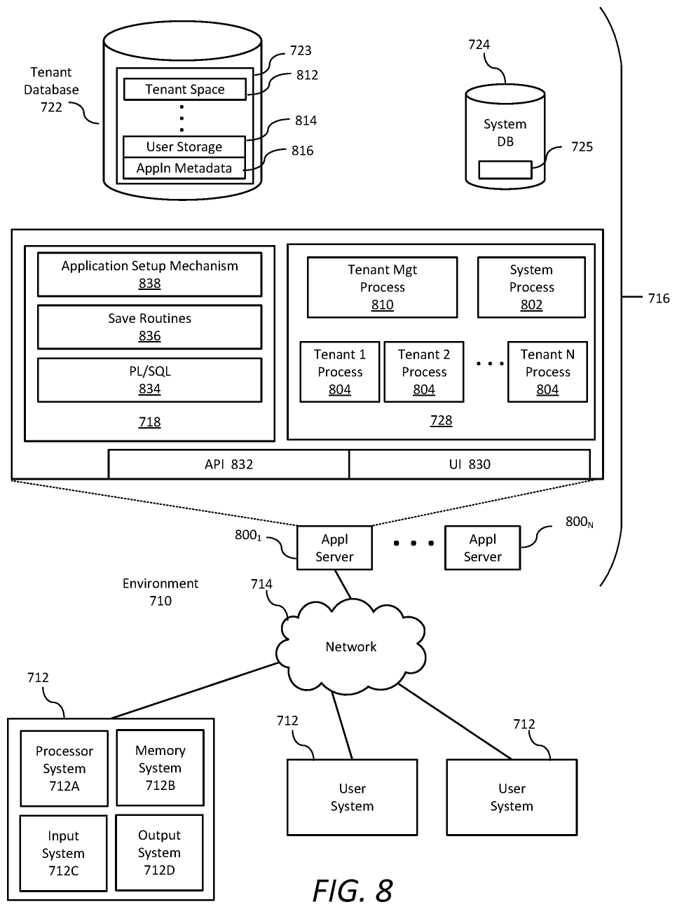

FIG. 1 is an illustration of an apparatus or system to perform deduplication of server API calls according to one or more embodiments. As illustrated in FIG. 1, multiple components 110 of a client 105 are operable to make server calls to an API 155 of a server 150. The server 150 may include, but is not limited to, a database system, such as a multi-tenant database system. The server 150 may include a system such as system 716 illustrated in FIGS. 7 and 8. The components 110 may include components representing one or more user systems, such as a user system 712 illustrated in FIGS. 7 and 8. A system may further include one or more other clients 140, which may also provide server calls to the API 155 of server 150. As illustrated in FIG. 1, client 105 further includes a network interface 117, and server includes a network interface 157 (such as network interface 720 illustrated in FIG. 7). For ease of illustration, the client network interface 117 and server network interface 157 are not repeated in FIGS. 2-5.

In some embodiments, the client 105 includes one or more intermediary layers such as intermediary layer 115, between the components 110 and the API 155 (via the network connection between network interface 117 of the client 105 and the network interface 157 of the server 150), wherein the layer 115 operates to perform deduplication of the server calls 120. The one or more intermediary layers are to provide one or more deduplicated server calls 130 to be transmitted to the API 155. In some embodiments, the deduplication of server calls 120 may include the intermediary layer 115 to receive or obtain the server calls 120 from the components 110, and, based at least in part on such server calls, generate one or more combined server calls 130 (which may be a single combined server call) to transmit to the API 155.

In some embodiments, the intermediary layer 115 is further to receive one or more responses 135 to the one or more deduplicated server calls 130 (which may include one or more combined server calls), and to generate and provide responses 125 to the original server calls 120 based at least in part on the one or more responses of the system 150 to the deduplicated server calls 130. In some embodiments, the generation of deduplicated server calls may be dependent upon each of a plurality of server calls being received within a certain threshold time period for deduplication such that server calls received by the intermediary layer 115 within, for example, time intervals of X seconds are subject to deduplication. However, embodiments are not limited to this particular threshold time period, and may, for example, be measured from receipt of a first server call, or other time threshold.

In this manner, the layer 115 allows each of the components 110 to operate in a normal manner for server API calls, making API calls for the component as required, while also reducing traffic to and from the API 155 through the deduplication of the server calls.

FIG. 2 is an illustration of deduplication of server API calls in an apparatus or system according to one or more embodiments. As illustrated in FIG. 2, each of multiple components 210 of client 205 provide server calls 220 to an API 255 of a server 250. In the example shown in FIG. 2, Component-1 is requesting data elements a and b; Component-2 is requesting data elements a and c; Component-3 is requesting data elements a and b; and Component-4 is requesting data element c. In this example, there is full duplication of server calls between Component-1 and Component-3, and partial duplication for server calls of Component-2 and Component-4. For the purposes of FIG. 2, each of the server calls 220 is within an applicable threshold time period for deduplication, such as each of the server calls 220 being received within a certain time interval.

In some embodiments, the client 205 includes one or more intermediary layers such as layer 215, between the components 210 and the API 255 of the system 250, wherein the layer 215 operates to perform deduplication of the server calls 220. In some embodiments, the layer 215 is to receive the server calls 220 from the components, and, based at least in part on such server calls, generate one or more combined server calls 240 (which in this example is single combined server call) to transmit to the API 234. In the illustrated example, the intermediary layer 232 is to generate a single combined server call to request data elements a, b, and c, which will satisfy the server calls for each of the components 210. In some embodiments, the client 205 may also choose to deduplicate the individual server calls from the components 210 such as, in the example illustrated in FIG. 2, if component-1 has requested data elements a and b and there is an outstanding server call 240 to the API 255, the intermediary layer 215 may prevent the additional call from component-3 for data elements a and b from being directed to the API 255.

In some embodiments, after the transmission of the combined server call to request data elements a, b, and c, the layer 215 may then receive a response 245 to the combined server calls 240, with the response 245 including the data elements a, b, and c. The layer 215 is then to generate a response 225 for each of the original server calls 220, with the responses in this example thus being a first response to be transmitted to Component-1 to provide data elements a and b; a second response to be transmitted to Component-2 to provide data elements a and c; a third response to be transmitted to Component-3 to provide data elements a and b; and a fourth response to be transmitted to Component-4 to provide data element c.

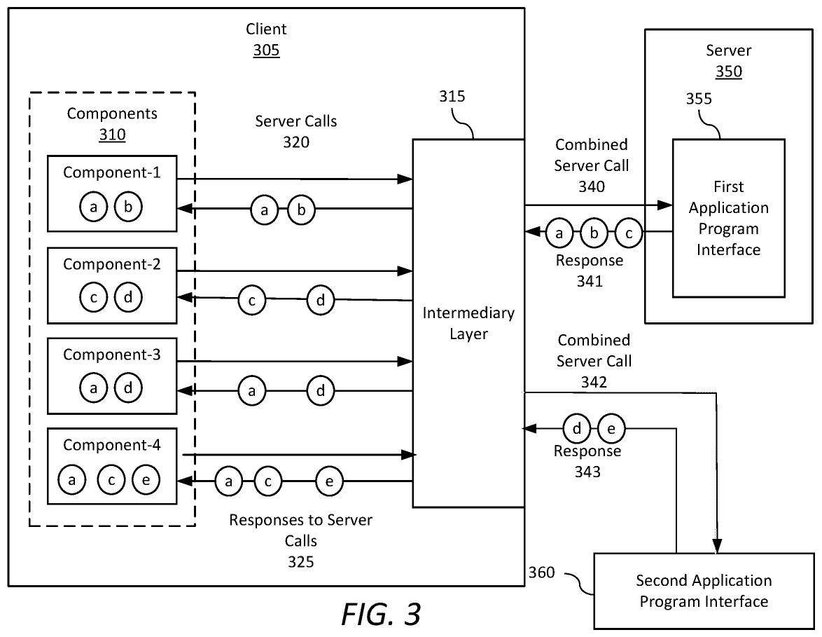

FIG. 3 is an illustration of deduplication of server API calls to multiple APIs in an apparatus or system according to one or more embodiments. As illustrated in FIG. 3, each of multiple components 310 of a client 305 provide server calls to one or more of multiple APIs, such as a first API 355 and a second API 360. In a particular example, the first API 355 may be an internal API of a server 350 while the second API 360 may be an external API. However, embodiments are limited to a particular combination of APIs.

In the example shown in FIG. 3, Component-1 is requesting data elements a and b from the first API 355; Component-2 is requesting data element c from the first API 355 and data element d from the second API 360; Component-3 is requesting data element a from the first API 355 and data element d from the second API 360; and Component-4 is requesting data elements a and c from the first API 355 and data element e from the second API 360.

In this example, there is partial duplication of server calls between the components. Further, data elements a, b, and c are data elements requested from the first API 355 and data elements d and e are data elements requested from the second API 360. Thus, not only are there duplicative server calls, the calls are to be directed to multiple APIs, thus potentially creating multiple server requests at multiple APIs.

In some embodiments, the client 305 includes one or more intermediary layers such as layer 315, between the components 310 and the APIs 355 and 360, wherein the layer 315 operates to perform deduplication of the server calls 320 to each of the multiple APIs. In the illustrated implementation, the layer 315 is to receive the server calls 320 from the components 310, and is to perform deduplication of such server calls. For example, based on such server calls, the layer 315 may generate one or more combined server calls to each of the multiple APIs, such as a first combined server call 340 and a second combined server call 342 to transmit respectively to the first API 355 and the second API 360. In the illustrated example, the intermediary layer 315 is to generate the first combined server call 340 to request data elements a, b, and c from the first API 355 and the second combined server call 342 from the second API 360.

In this example, the layer 315 is then to receive a response 341 to the first combined server call 340, with the response including the data elements a, b, and c, and a second response 343 to the second combined server call 342, with the response including data elements d and e. The layer 315 is then to generate a response 325 for each of the original server calls 320, with the responses in this example thus being a first response to be transmitted to Component-1 to provide data elements a and b; a second response to be transmitted to Component-2 to provide data elements c and d; a third response to be transmitted to Component-3 to provide data elements a and d; and a fourth response to be transmitted to Component-4 to provide data elements a, b, and e. In some embodiments, the responses to the server calls may be separated according to APIs providing the responses, and thus, for example, a response may be generated and transmitted to Component-4 to provide data elements a and b from the first API 355, and a response may be generated and transmitted to Component-4 to provide data element e from the second API 360.

In some embodiments, an apparatus, system, or process may provide for further deduplication of server calls through caching of data in response from one or more APIs, thus allowing for generation of a response without requiring certain data to be requested from the one or more APIs. In some embodiments, the caching may be available for server calls received within a certain threshold time period, which may be the same or different from a time period for selection of server calls for deduplication. For example, the cached data values may expire after Y seconds, or other time threshold related to the caching of data.

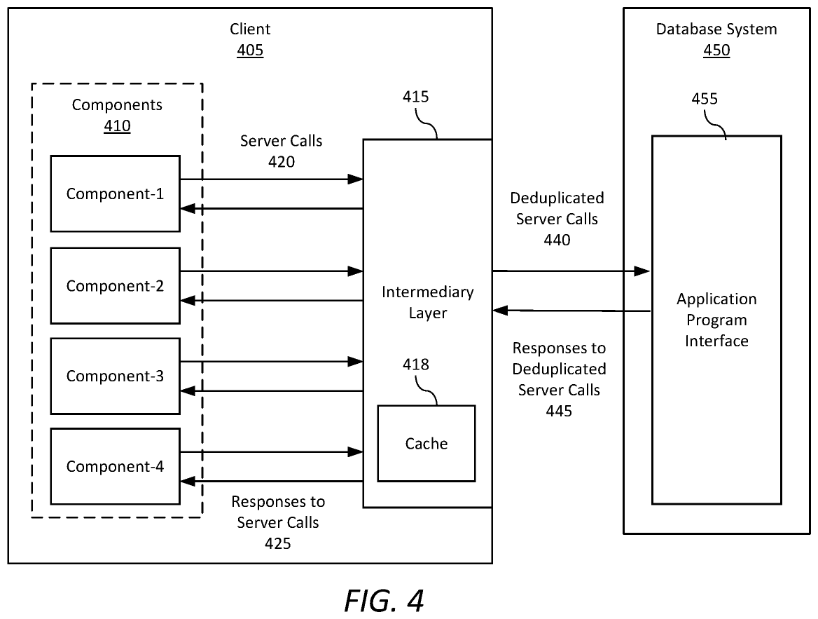

FIG. 4 is an illustration of an apparatus or system to perform deduplication of server API calls including use of data caching according to one or more embodiments. As illustrated in FIG. 4, multiple components 410 of a client 405 are operable to make server calls to one or more APIs, such as API 455. However, the APIs may include one or more APIs of the server 450, one or more external APIs, or both. The server 450 may include, but is not limited to, a database system, such as a multi-tenant database system.

In some embodiments, the client 405 includes one or more intermediary layers such as intermediary layer 415, between the components 410 and the API 455, wherein the layer 415 operates to perform deduplication of the server calls 420. In some embodiments, the intermediary layer 415 includes a cache element 418 for the storage of data element values that have been previously received. The intermediary layer 415 is to receive the server calls 420 from the components 410, and, based on such server calls and on values contained in the cache element 418, if necessary (when data element values are not available in the cache 418) generate one or more deduplicated server calls 440 (which may include one or more combined server calls) to transmit to the API 455. In some embodiments, the intermediary layer 415 is further to receive responses 445 to the one or more deduplicated server calls 440 (if required), and to generate and transmit responses 425 to the original server calls 420 based on the cached data and the data received from the API 455. In some embodiments, the generation of deduplicated server calls may be dependent upon server calls being received within a certain first threshold time period for deduplication such that server calls received by the intermediary layer 415. In some embodiments, the use of cache data may be dependent upon server calls being received within a certain second threshold time period.

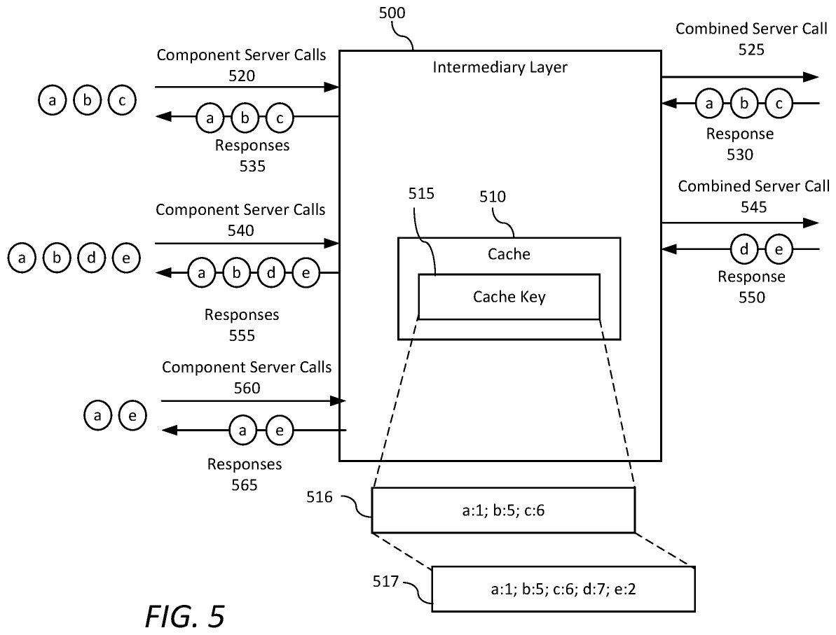

FIG. 5 is an illustration of an apparatus or system to perform deduplication of server API calls including use of data caching according to one or more embodiments. As illustrated in FIG. 5, an intermediary layer 500, such as intermediary layer 415 of client 405 illustrated in FIG. 4, includes a cache element 510 for use in deduplication of server calls. The cache element may provide for caching of data in a general computer memory, in a separate cache memory, in one or more registers, or in any other storage that is accessible to the intermediary layer 500.

In the illustrated example in FIG. 5, one or more server calls may request data elements a, b, and c. Assuming that the cache element 510 does not initially contain any of such values, the intermediary layer is to request a, b, and c from an API in a combined server call 530 and receive a response 530 containing such values from the API. In a particular implementation, the cache element 510 may generate and maintain a cache key 515 (or other similar element) including cached values. In FIG. 5, in addition to generating one or more responses 535 to the original server calls 520, in the intermediary layer 500 is generate (or modify) the cache key based on inputs for the server calls, and may update values associated with the cache key 515 with data received from the server, shown in FIG. 5 as “a:1; b:5; c:6” in a particular set of cache key values 516. While the data values are simple integer values for ease of illustration, embodiments are not limited to any particular type or quantity of data elements.

In some embodiments, the intermediary layer is to utilize values in the cache 510 to further improve efficiency in deduplication of server calls. In a particular example, the intermediary layer 500 may receive one or more component server calls 540 that request data elements a, b, d, and e. In this case, the values of a and b are contained in the cache key 515 (assuming that the values remain valid within a certain threshold time period), and thus only the values of d and e are not known. In some embodiments, the intermediary layer 500 is to generate one or more combined server calls 545 based on both the receive component server calls 540 and the current cached data 516 in the cache key 515, resulting in generation of a combined server call that only request data elements d and e in this example. As illustrated in FIG. 5, a response 550 is received from the API containing the values for d and e. The intermediary layer 500 is then to generate one or more responses 555 to the original component calls 540 to provide the values for data elements a, b, d, and e. The intermediary layer 500 is further to update the values associated with cache key to include the new values for d and e, which in this example are d=7 and e=2.

In another example, the intermediary layer 500 may receive one or more component server calls 560 that request data elements a and e. In this case, the values of a and e are both associated with the cache key 515 (assuming that the values remain valid within a certain threshold time period), and thus all values are cached. In some embodiments, the intermediary layer 500 is to generate one or more responses 565 to the original component calls 560 to provide the values for data elements a and e, without requiring the generation of a combined server call to the API.

In some embodiments, operation of the intermediary layer 500 may further provide for maintaining values contained in the cache by updating the cache key with new values. In some embodiments, the intermediary layer 500 may request values of data elements that have been previously received to provide an updated cache key that can be utilized in following server calls.

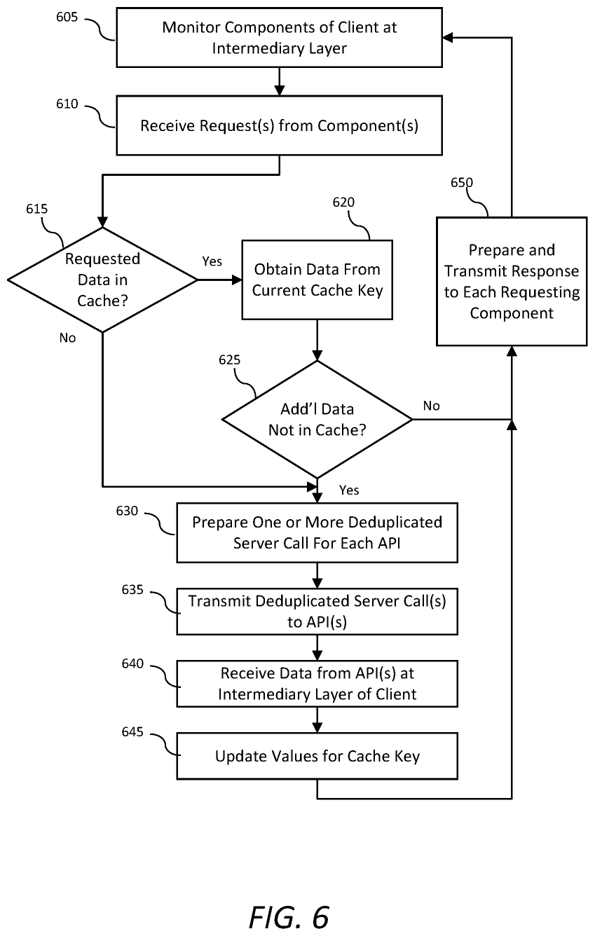

FIG. 6 is a flow chart to illustrate a process for deduplication of server calls according to one or more embodiments. In some embodiments, a process includes monitoring of server calls from multiple components of a client at an intermediary layer 605. Upon receiving one or more server calls from components 610, which may include one or more server calls being received within a certain time threshold, the process provides for deduplication of the server calls.

In some embodiments, the deduplication process includes a determination whether any portion of the requested data is contained in a cache 615, such as cache 510 of intermediary layer 500 illustrated in FIG. 5. If at least a portion of the data is contained in the cache, then the portion of the data is obtained from the current cache key 620. There is then a determination whether there is additional data requested that is not contained in the cache 625.

In some embodiments, upon a determination that the requested data was not contained in the cache 615 or a determination that there is additional requested data that is not contained in the cache 625, the process continues with preparing one or more deduplicated server calls (which may include one or more combined server calls) for each respective API 630. In some embodiments, when there is partial data in the cache, all data from the server may be re-requested in order to refresh data values in the cache. In an example, if the cache includes fields for elements a, b, and c, and there is a request for elements a and d, a request to the server may be made for data elements a, b, c, and d. The one or more deduplicated server calls are transmitted to the one or more APIs 635, with the requested data then being received from the one or more APIs at the intermediary layer 640. In some embodiments, the intermediary layer may further update the cache key with any new or revised values that are received from the one or more APIs 645.

In some embodiments, upon a determination that there is no additional requested data that was not contained in the cache 625 or upon completion of receipt of data from the one or more APIs 640 (and updating of cache key 645), the process then continues with preparing and transmitting a response to each requesting component 650, with the generated response being based at least upon data contained in the cache, data received from the one or more APIs, or both.

The examples illustrating the use of technology disclosed herein should not be taken as limiting or preferred. The examples are intended to sufficiently illustrate the technology disclosed without being overly complicated and are not intended to illustrate all of the technologies disclosed. A person having ordinary skill in the art will appreciate that there are many potential applications for one or more implementations of this disclosure and hence, the implementations disclosed herein are not intended to limit this disclosure in any fashion.

One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Implementations may include:

In some embodiments, an apparatus includes one or more processors to process data; a computer memory; and a network interface, wherein the apparatus includes an intermediary layer between one or more components of the apparatus and the network interface, the intermediary layer to perform deduplication of a plurality of server API calls from one or more components for the one or more APIs, wherein the deduplication includes one or more of preventing transmission of duplicated server calls of the plurality of server calls from the one or more components to the one or more APIs; and generating one or more combined server calls based at least in part on the plurality of server API calls and transmitting the one or more combined server calls to the one or more APIs.

In some embodiments, the one or more combined server calls includes a single combined server call representing required data for each of the plurality of server API calls.

In some embodiments, deduplication further includes generating a plurality of responses for the plurality of server API calls based at least in part on one or more responses to the one or more combined server calls from the one or more APIs and transmitting the plurality of responses to the one or more components.

In some embodiments, the intermediary layer is further to cache received API server call data, and wherein the generation of the one or more combined server calls is further based on the cached server call data.

In some embodiments, upon a determination that the cached server call data includes a portion of requested data, the generation of the one or more combined server calls includes request of all cached server data to refresh cache values.

In some embodiments, upon a determination that all data required for the plurality of responses is contained in the cached server call data, the intermediary layer is to generate the plurality of responses without generation of the one or more combined server calls.

In some embodiments, one or more APIs includes at least one API that is external to the apparatus.

In some embodiments, the apparatus includes a client in a database system.

In some embodiments, a method includes generating a plurality of server calls by components of a client for one or more application program interfaces (APIs); and performing deduplication of the plurality of server API calls received at an intermediary layer from one or more components for one or more application program interfaces (APIs), wherein the deduplication includes one or more of preventing transmission of duplicated server calls of the plurality of server calls from the one or more components to the one or more APIs, and generating one or more combined server calls based at least in part on the plurality of server API calls and transmitting the one or more combined server calls to the one or more APIs.

In some embodiments, the one or more combined server calls includes a single combined server call representing required data for each of the plurality of server API calls.

In some embodiments, the method further includes generating a plurality of responses for the plurality of server API calls based at least in part on one or more responses to the one or more combined server calls from the one or more APIs, and transmitting the plurality of responses to the one or more components.

In some embodiments, the method further includes caching received API server call data, wherein the generation of the one or more combined server calls is further based on the cached server call data.

In some embodiments, the method further includes, upon a determination that the cached server call data includes a portion of requested data, generating the one or more combined server calls to include request of all cached server data to refresh cache values.

In some embodiments, the method further includes, upon a determination that all data required for the plurality of responses is contained in the cached server call data, generating the plurality of responses without generation of the one or more combined server calls.

In some embodiments, the method further includes updating the cached server data based on the one or more responses from the one or more APIs.

In some embodiments, one or more APIs includes at least one external API.

In some embodiments, one or more non-transitory computer-readable storage mediums have stored thereon executable computer program instructions that, when executed by one or more processors, cause the one or more processors to perform operations including generating a plurality of server calls by components of a client for one or more application program interfaces (APIs); and performing deduplication of the plurality of server API calls received at an intermediary layer from one or more components for one or more application program interfaces (APIs), wherein the deduplication includes one or more of preventing transmission of duplicated server calls of the plurality of server calls from the one or more components to the one or more APIs, and generating one or more combined server calls based at least in part on the plurality of server API calls and transmitting the one or more combined server calls to the one or more APIs.

In some embodiments, the one or more combined server calls includes a single combined server call representing required data for each of the plurality of server API calls.

In some embodiments, the one or more storage mediums include instructions for generating a plurality of responses for the plurality of server API calls based at least in part on one or more responses to the one or more combined server calls from the one or more APIs, and transmitting the plurality of responses to the one or more components.

In some embodiments, the one or more storage mediums include instructions for caching received API server call data, wherein the generation of the one or more combined server calls is further based on the cached server call data.

In some embodiments, the one or more storage mediums include instructions for, upon a determination that the cached server call data includes a portion of requested data, generating the one or more combined server calls to include request of all cached server data to refresh cache values.

In some embodiments, the one or more storage mediums include instructions for, upon a determination that all data required for the plurality of responses is contained in the cached server call data, generating the plurality of responses without generation of the one or more combined server calls.

In some embodiments, the one or more storage mediums include instructions for updating the cached server data based on the one or more responses from the one or more APIs.

In some embodiments, one or more APIs includes at least one external API.

FIG. 7 illustrates a block diagram of an environment in which an on-demand database service may be provided. In some embodiments, the environment 710 includes deduplication of server API calls, such as illustrated in FIGS. 1-6. The environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

Environment 710 is an environment in which an on-demand database service exists. User system 712 may be any machine or system that is used by a user to access a database user system. For example, any of user systems 712 can be a handheld computing device, a smart phone, a laptop or tablet computer, a work station, and/or a network of computing devices. As illustrated in herein FIG. 7 and in more detail in FIG. 8, user systems 712 may interact via a network 714 with an on-demand database service, such as system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” may be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third-party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third-party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop or tablet computer, smart phone, or any wireless access protocol (WAP) enabled device or any other computing device capable of interfacing directly or indirectly to the Internet or other network connection. User system 712 typically runs an HTTP client, e.g., a browsing program (also referred to as a web browser or browser), such as Edge or Internet Explorer from Microsoft, Safari from Apple, Chrome from Google, Firefox from Mozilla, or a WAP-enabled browser in the case of a smart phone or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, touch pad, touch screen, pen, voice interface, gesture recognition interface, or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Core series processor or the like. Similarly, system 716 (and additional instances of an MTS, where more than one is present) and all of their components might be operator configurable using application(s) including computer code to run using a central processing unit such as processor system 717, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk or solid state drive (SSD), but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 illustrates further details of an environment in which an on-demand database service may be provided. FIG. 8 provides further detail regarding elements of system 716. In addition, various interconnections in an embodiment are provided. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 800₁-800_{N}, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long-term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800_{N} might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 BIG-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described, but can be practiced with modification and alteration within the spirit and scope of the appended claims. The description is thus to be regarded as illustrative instead of limiting.

What is claimed is:

1. An apparatus comprising:
one or more processors to process data;
a computer memory; and
a network interface, wherein the apparatus includes an intermediary layer between one or more components of the apparatus and the network interface, the intermediary layer to perform deduplication of a plurality of server API calls from one or more components for the one or more APIs, wherein the deduplication includes one or more of:
preventing transmission of duplicated server calls of the plurality of server calls from the one or more components to the one or more APIs; and
generating one or more combined server calls based at least in part on the plurality of server API calls and transmitting the one or more combined server calls to the one or more APIs.

2. The apparatus of claim 1, wherein the one or more combined server calls includes a single combined server call representing required data for each of the plurality of server API calls.

3. The apparatus of claim 1, wherein deduplication further includes generating a plurality of responses for the plurality of server API calls based at least in part on one or more responses to the one or more combined server calls from the one or more APIs and transmitting the plurality of responses to the one or more components.

4. The apparatus of claim 3, wherein the intermediary layer is further to cache received API server call data, and wherein the generation of the one or more combined server calls is further based on the cached server call data.

5. The apparatus of claim 4, wherein, upon a determination that the cached server call data includes a portion of requested data, the generation of the one or more combined server calls includes request of all cached server data to refresh cache values.

6. The apparatus of claim 4, wherein, upon a determination that all data required for the plurality of responses is contained in the cached server call data, the intermediary layer is to generate the plurality of responses without generation of the one or more combined server calls.

7. The apparatus of claim 1, wherein one or more APIs includes at least one API that is external to the apparatus.

8. The apparatus of claim 1, wherein the apparatus includes a client in a database system.

9. A method comprising:
generating a plurality of server calls by components of a client for one or more application program interfaces (APIs); and
performing deduplication of the plurality of server API calls received at an intermediary layer from one or more components for one or more application program interfaces (APIs), wherein the deduplication includes one or more of:
preventing transmission of duplicated server calls of the plurality of server calls from the one or more components to the one or more APIs, and
generating one or more combined server calls based at least in part on the plurality of server API calls and transmitting the one or more combined server calls to the one or more APIs.

10. The method of claim 9, wherein the one or more combined server calls includes a single combined server call representing required data for each of the plurality of server API calls.

11. The method of claim 9, further comprising:
generating a plurality of responses for the plurality of server API calls based at least in part on one or more responses to the one or more combined server calls from the one or more APIs, and
transmitting the plurality of responses to the one or more components.

12. The method of claim 9, further comprising:
caching received API server call data, wherein the generation of the one or more combined server calls is further based on the cached server call data.

13. The method of claim 12, further comprising:
upon a determination that the cached server call data includes a portion of requested data, generating the one or more combined server calls to include request of all cached server data to refresh cache values.

14. The method of claim 12, further comprising:
upon a determination that all data required for the plurality of responses is contained in the cached server call data, generating the plurality of responses without generation of the one or more combined server calls.

15. The method of claim 12, further comprising:
updating the cached server data based on the one or more responses from the one or more APIs.

16. The method of claim 9, wherein one or more APIs includes at least one external API.

17. One or more non-transitory computer-readable storage mediums having stored thereon executable computer program instructions that, when executed by one or more processors, cause the one or more processors to perform operations comprising:
generating a plurality of server calls by components of a client for one or more application program interfaces (APIs); and
performing deduplication of the plurality of server API calls received at an intermediary layer from one or more components for one or more application program interfaces (APIs), wherein the deduplication includes one or more of:
preventing transmission of duplicated server calls of the plurality of server calls from the one or more components to the one or more APIs, and
generating one or more combined server calls based at least in part on the plurality of server API calls and transmitting the one or more combined server calls to the one or more APIs.

18. The one or more storage mediums of claim 17, wherein the one or more combined server calls includes a single combined server call representing required data for each of the plurality of server API calls.

19. The one or more storage mediums of claim 17, further including executable computer program instructions that, when executed by the one or more processors, cause the one or more processors to perform operations comprising:
generating a plurality of responses for the plurality of server API calls based at least in part on one or more responses to the one or more combined server calls from the one or more APIs, and
transmitting the plurality of responses to the one or more components.

20. The one or more storage mediums of claim 19, further including executable computer program instructions that, when executed by the one or more processors, cause the one or more processors to perform operations comprising:
caching received API server call data, wherein the generation of the one or more combined server calls is further based on the cached server call data.

21. The one or more storage mediums of claim 20, further including executable computer program instructions that, when executed by the one or more processors, cause the one or more processors to perform operations comprising:
upon a determination that the cached server call data includes a portion of requested data, generating the one or more combined server calls to include request of all cached server data to refresh cache values.

22. The one or more storage mediums of claim 20, further including executable computer program instructions that, when executed by the one or more processors, cause the one or more processors to perform operations comprising:
upon a determination that all data required for the plurality of responses is contained in the cached server call data, generating the plurality of responses without generation of the one or more combined server calls.

23. The one or more storage mediums of claim 20, further including executable computer program instructions that, when executed by the one or more processors, cause the one or more processors to perform operations comprising:
updating the cached server data based on the one or more responses from the one or more APIs.

24. The one or more storage mediums of claim 17, wherein one or more APIs includes at least one external API.
